(19) United States
(12) Patent Application Publication
(10) Pub. No.: US 2022/0200143 A1
(43) Pub. Date: Jun. 23, 2022

(54) APPARATUS FOR REDUCING INTERFERENCE IN ANTENNA FROM CO-FREQUENCY RADIO WAVE

(71) Applicant: Changlai GUO, Dezhou, Shandong (CN)

(72) Inventor: Changlai GUO, Dezhou, Shandong (CN)

(21) Appl. No.: 17/599,874

(22) PCT Filed: Apr. 6, 2020
(86) PCT No.: PCT/CN2020/083420

§ 371 Date: Sep. 29, 2021

(30) Foreign Application Priority Data
Apr. 8, 2019 (CN) 201910277693.1

(51) Int. Cl. H01Q 1/52; H01Q 17/00; H01Q 15/00

(52) U.S. Cl. CPC H01Q 1/526; H01Q 15/0013; H01Q 17/008

(57) ABSTRACT

An apparatus for reducing interference in an antenna from a radio wave is provided. A method for blocking an electromagnetic wave signal port is used. A WiFi antenna is enclosed by using an electromagnetic wave blocking material (such as an aluminum metal mesh) to form an enclosure surrounding the WiFi antenna. The enclosure is provided with one or more electromagnetic wave signal ports, to form an electromagnetic wave selection enclosure (wave selection enclosure). When a wavelength satisfies a requirement, an electromagnetic wave having a signal with sufficient strength, or a signal in an appropriate direction with insufficient strength (for example, entering the signal port in a route closer to a linear route) is allowed to enter the enclosure and communicate with the antenna, reducing or eliminating mainly interference in the antenna in the enclosure from another co-frequency electromagnetic wave outside the enclosure.

### CROSS REFERENCE TO RELATED APPLICATION(S)

This patent application claims the benefit and priority of Chinese Patent Application No. 201910277693.1, filed on Apr. 8, 2019, the disclosure of which is incorporated by reference herein in its entirety as part of the present application.

### TECHNICAL FIELD

The present disclosure relates to an apparatus for reducing interference in an antenna from an electromagnetic wave, which belongs to the field of radio anti-interference.

### BACKGROUND ART

Currently, interference is reduced on condition that frequencies are different. For co-frequency electromagnetic waves, it is difficult to find anti-interference measures for an antenna. Nearly all technologies can hardly be used for resolving co-frequency interference.

### Technical Issue

Currently, frequency bands of most wireless WiFi signals are 2.4 GHz. The frequency band is often interfered by another router due to the co-frequency or frequency adjacency, causing slow Internet access speed and frequent “frame freezing” for mobile phones with WiFi functions. Although the 2.4 GHz frequency band is divided into approximately 13 channels, an increasing number of families are using WiFi nowadays, resulting in insufficient channels and frequent mutual interference. As too many adjacent users use the router, it is increasingly difficult to reduce frequency interference by arranging different channels. Although the frequency bands of WiFi signals may include 5 GHz, few devices are supported, and signal penetration is poor.

### SUMMARY

In consideration that electromagnetic waves are characterized by diffraction (diffraction) when transmitted, compared with those during linear transmission, the electromagnetic waves during diffraction attenuate more severely, and electromagnetic waves from different sources in space have different signal strength and transmission directions. In the present disclosure, the following technical solution is used: A method for blocking an electromagnetic wave signal port is used. A WiFi antenna or the entire router is enclosed by using an electromagnetic wave blocking material (such as an aluminum metal mesh) to form an enclosure surrounding the WiFi antenna. The enclosure is provided with one or more electromagnetic wave signal ports (a size of the opening can be selected based on a wavelength of an electromagnetic wave), to form an electromagnetic wave selection enclosure (wave selection enclosure), and the enclosure can perform selection on electromagnetic waves with different strength or in different directions or from different sources. When the wavelength satisfies a requirement for entering the signal port, an electromagnetic wave having a signal with sufficient strength, or a signal in an appropriate direction with insufficient strength, or a signal in an inappropriate direction with sufficient strength (that is, two factors of the strength and the direction jointly satisfy requirements) is allowed to enter the enclosure and communicate with the antenna, reducing or eliminating mainly interference caused by another co-frequency electromagnetic wave outside the enclosure for the antenna in the enclosure. The appropriate direction refers to a direction in which it is easier to enter the signal opening to reach the antenna, such as an incident direction closer to a straight line for entering the signal opening (the smaller the angle of diffraction is, the easier the antenna will be reached, and the smaller the attenuation of the required diffraction will be), or through the reflection of the signal, it is easier to reflect to the incident direction of the antenna in the enclosure. The direction adequacy also depends on the wavelength. The longer the wavelength is, the lower the requirements for the direction will be. In addition, the direction adequacy also depends on the strength of the electromagnetic wave. A remaining value after the attenuation of the diffraction is not excessively small only if the strength is sufficient, and as a result, the requirement for the direction is reduced. In brief, the main interference filtered out in the solution is interference from co-frequency electromagnetic waves with insufficient strength in an inappropriate direction (a required diffraction angle is large, or a reflection angle is inadequate). This is because these electromagnetic waves cannot enter the electromagnetic wave selection enclosure, or reaches or acts on the antenna.

Regarding the size of the signal port, it is necessary to ensure that a signal with a frequency or a wavelength used by the antenna in the enclosure can enter and exit from the signal port and reach the antenna in the enclosure. Generally, the size of the signal port needs to be greater than a quarter of the wavelength of the electromagnetic wave used by the antenna. However, this is not an absolute requirement because electromagnetic waves can reach a specific distance and depth through a signal port with a smaller size. The smaller the size of the signal port is, the smaller the distance and depth from the signal port reached by the electromagnetic wave will be. If the antenna in the enclosure is very close to the signal port, this is equivalent to a case that electromagnetic waves of the wavelength can enter the signal port. Therefore, regarding the problem, Claims specify a requirement that the wavelength satisfies a requirement for entering the signal port (which depends on the size of the signal port and a distance between the antenna in the enclosure and the signal port).

The larger the solid angle of enclosing the internal antenna by the electromagnetic wave selection enclosure (wave selection enclosure) mentioned in the present disclosure is, the less the interference will be (however, this is also likely to block transmission of useful signals, but this is not severe). For a purpose of quantification, the solid angle of enclosing the internal antenna by the electromagnetic wave selection enclosure (wave selection enclosure) should be greater than 2π (it is the pi), or greater than 50% of the solid angle of the sphere.

Further, to help miniaturize the device in the present disclosure, on a plane perpendicular to the signal port, only one dimension of the signal port is greater than a quarter of a wavelength of the electromagnetic wave (the electromagnetic wave of the communications antenna in the enclosure), and the other dimensions are less than a quarter of the wavelength of the electromagnetic wave. As for only one dimension, a direction that forms an angle less than 80 degrees with the dimension or a direction that is not perpendicular to the dimension is acceptable. When satisfying the requirement for the only one dimension, the electromagnetic waves can pass through the signal port.

Further, the electromagnetic wave blocking material used is an electric conductor and/or a magnetic conductor, and the material may be mesh-shaped, such as a metal layer or a metal mesh, such as an aluminum mesh or a copper mesh.

Further, the device is intended to reduce or eliminate co-frequency interference or adjacent frequency interference, such as co-frequency or adjacent frequency interference caused for the WiFi router.

Further, because an interference signal can be received only when signals are being received, the wave selection enclosure can only cover a signal receiving antenna, and a signal transmission antenna is provided outside the enclosure. In this way, the wave selection enclosure does not affect signal transmission by the antenna; or a number of signal receiving antennas in the wave selection enclosure is greater than a number of signal emitting antennas.

Further, to further filter out a weak interference signal entering from the signal port and reduce disturbance caused by a reflected signal of the electromagnetic wave, an electromagnetic wave absorption technology can be used. The wave absorption technology (including a wave absorption structure and/or a wave absorption material or a grounding technology, such as a ferrite wave-absorbing material) is used for a part or all of the electromagnetic wave selection enclosure (wave selection enclosure), or is used inside and/or outside the enclosure. For example, the wave absorption material or technology is used for the signal port. The wave absorption technology or the wave absorption material mentioned in the present disclosure includes, but is not limited to, a known technology or material, for example, known technologies of a non-smooth metal surface or a metal surface with wedges or barbs, or the ferrite wave-absorbing material. In addition, in the present disclosure, the electromagnetic wave selection enclosure (wave selection enclosure) can alternatively be grounded to absorb the electromagnetic waves.

Further, a longer electromagnetic wave signal port can be provided, and a flaring opening with diameters expending from the inside to the outside or a narrowing opening with diameters shrinking from the inside to the outside may be provided. This is more conducive to a gradual change of a waveform of the electromagnetic wave signal without confusion, making the interference signal less likely to pass.

Further, the antenna in the enclosure may be a WiFi signal antenna (such as a WiFi antenna of a router), a 4G or 5G signal antenna of a mobile phone (or an antenna of a later generation, such as 6G or 7G), a WiFi antenna of the mobile phone, another antenna of device with a WiFi function, or an antenna of a communications device with Bluetooth.

Further, because signals facing a direction of the electromagnetic wave signal port of the electromagnetic wave selection enclosure are better and more adequate, the electromagnetic wave selection enclosure (wave selection enclosure) can be directly or indirectly installed on the rotating shaft to facilitate direction adjustment. The rotating shaft can be driven by a motor to rotate, and a control circuit controls the motor based on a set program to further control a rotating direction of the wave selection enclosure, thereby controlling a direction of the electromagnetic wave signal port of the wave selection enclosure. For example, a control circuit of the WiFi router (such as a central processing unit (CPU)) controls the motor based on the set program, to further control a rotation direction of the wave selection enclosure, thereby better receiving the useful signal and filtering out the interference signal.

Further, due to some reflection effects of the inner wall of the enclosure on the electromagnetic waves (including a case in which the wave absorption technology or the wave absorption material is used for a part), a signal at the signal port of the wave selection enclosure has strong strength, which can be used to enhance signal penetration in a direction of the signal port or increase a transmission distance in the direction of the signal port, for example, can be used for 5G (or 4G, or a later generation such as 6G or 7G) signal directional transmission of a mobile phone.

Further, in the present disclosure, a turning structure may also be used, so that an electromagnetic wave signal needs to pass through one turning structure (more turning structures) to reach the antenna in the enclosure after passing through the electromagnetic wave signal port of the wave selection enclosure, thereby reducing more interference by weak signals.

### Beneficial Effects

The beneficial effect of the present disclosure is that a space utilization rate of a radio frequency spectrum can be increased and even multiplied, and the interference caused to the WiFi router due to the co-frequency or frequency adjacency can be reduced with low costs, ensuring that the Internet access speed of the mobile phone or the computer through WiFi are more stable and faster and greatly reducing the situations of slow Internet access speeds and frame freezing. In the present disclosure, after an actual test, if the electromagnetic wave selection enclosure made of the aluminum mesh is used to surround the WiFi router, the Internet access speed of the mobile phone through the WiFi is obviously more stable and faster.

### BRIEF DESCRIPTION OF THE DRAWINGS

The following describes the present disclosure in more detail with reference to the accompanying drawings and examples.

FIG. 1 is a schematic cross-sectional view of an electromagnetic wave selection enclosure installed with a WiFi router according to the present disclosure;

FIG. 2 is a schematic three-dimensional diagram indicating that a cylindrical mesh structure is used for an electromagnetic wave blocking layer and a WiFi router is provided inside the enclosure with the cylindrical mesh structure according to the present disclosure;

FIG. 3 is a schematic diagram of applying a miniaturized apparatus to a router for further installation on an antenna according to the present disclosure;

FIG. 4 is a schematic diagram of applying the miniaturized apparatus in FIG. 2 to a router according to the present disclosure;

FIG. 5 is an enlarged view of the miniaturized apparatus with the electromagnetic wave selection enclosure 10 in FIG. 4; and

FIG. 6 is a cross-sectional view of a miniaturized apparatus with the electromagnetic wave selection enclosure 10 in FIG. 4 whose internal opening is round-shaped and extends from one end to form a long and narrow structure.

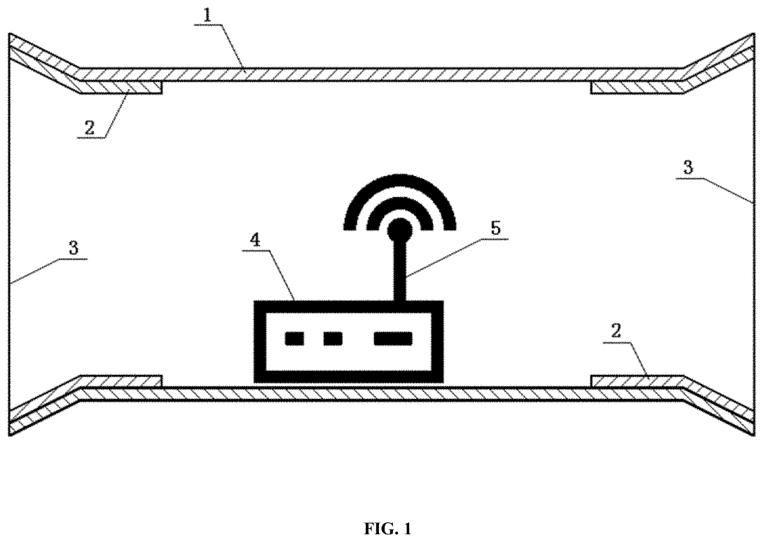

Reference numerals are described as follows: In FIG. 1, 1 electromagnetic wave blocking layer; 2 electromagnetic wave absorption material layer; 3 electromagnetic wave signal port; 4 user's router; and 5 WiFi antenna of a router.

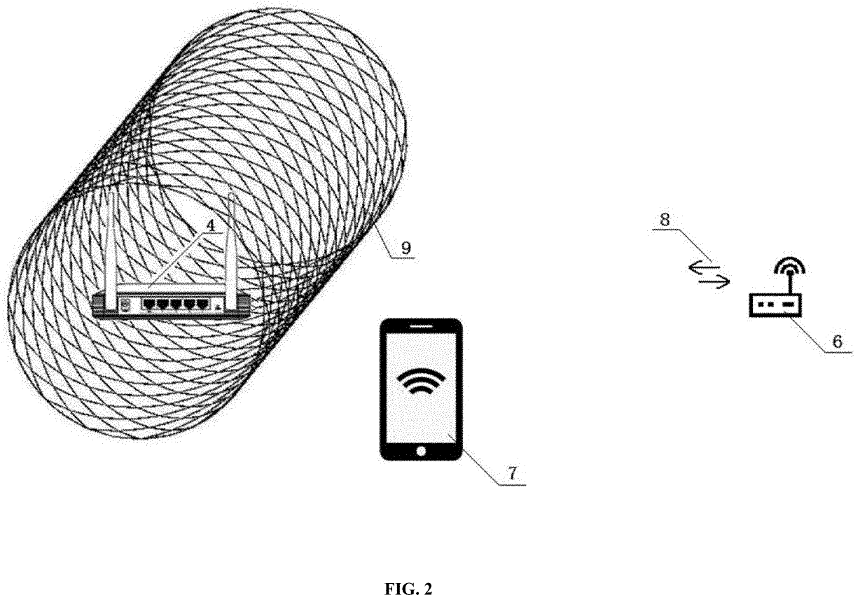

In FIG. 2, 4 user's router; 6 neighbor's router; 7 user's mobile phone; 8 symbol of a remote distance; and 9 cylindrical aluminum mesh enclosure.

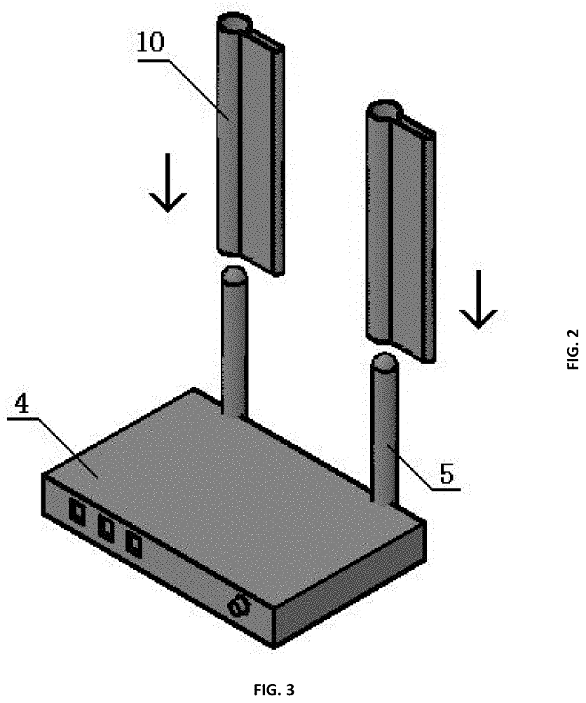

In FIG. 3, 10 miniaturized electromagnetic wave selection enclosure; 4 user's router; and 5 WiFi antenna of a router.

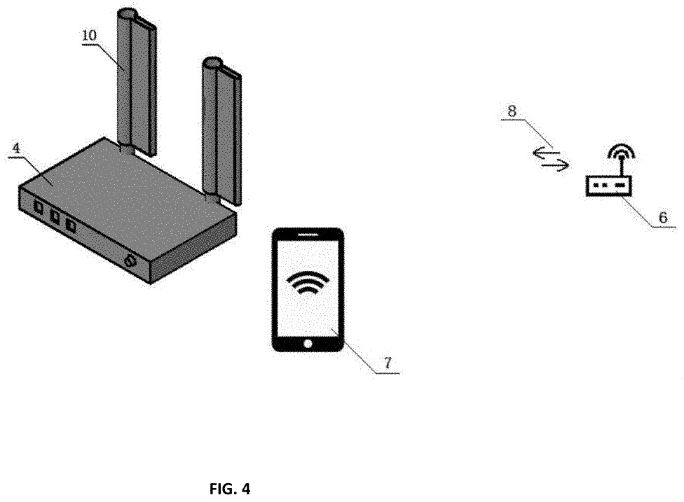

In FIG. 4, 10 miniaturized electromagnetic wave selection enclosure; 4 user's router; 6 neighbor's router; 7 user's mobile phone; and 8 symbol of a remote distance.

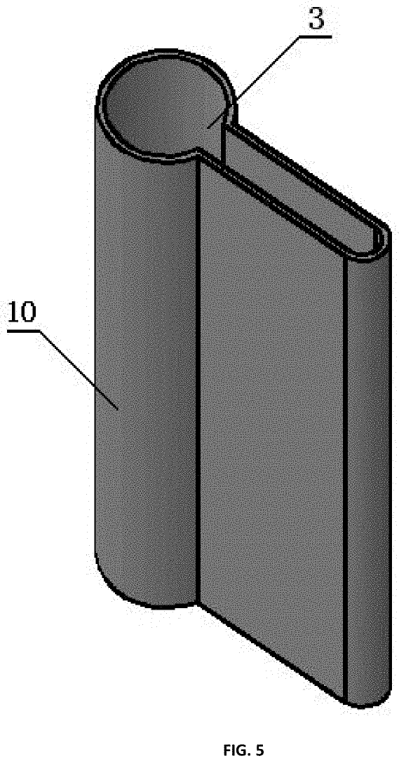

In FIG. 5, 10 miniaturized electromagnetic wave selection enclosure; and 3 electromagnetic wave signal port.

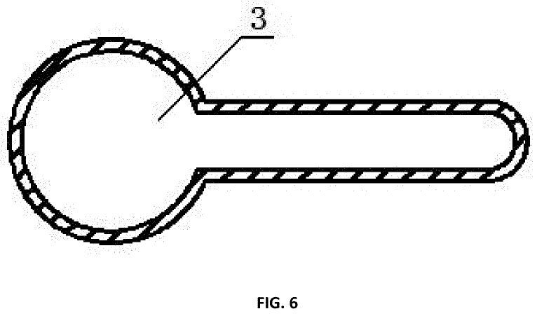

In FIG. 6, 3 electromagnetic wave signal port.

### DETAILED DESCRIPTION OF THE EMBODIMENTS

FIG. 4 is a schematic diagram of an application scenario of an assembled miniaturized electromagnetic wave selection enclosure 10 in FIG. 3 according to the present disclosure. The miniaturized electromagnetic wave selection enclosure 10 in the figure is made of aluminum metal or copper metal, and the enclosure is coated with a ferrite wave-absorbing material. An antenna of a user's router 4 is installed inside the miniaturized electromagnetic wave selection enclosure 10. Assuming that the electromagnetic wave signal port 3 faces upward, if interference signals are transmitted by the neighbor's router 6 from the east or the west, because there is a long distance indicated by a symbol of a remote distance 8 and signal strength is poor, most interference signals are blocked by the miniaturized electromagnetic wave selection enclosure 10. When passing through the electromagnetic wave signal port 3 in a non-linear route, some weaker interference signals are absorbed by a wave absorption material, thereby reducing interference caused for the router due to the co-frequency or frequency adjacency. However, the user's mobile phone 7 usually accesses the user's router 4 at home from a short distance with a stronger signal, even if the signal direction of the user's mobile phone is not in line with the signal port, remaining signals are still strong enough to circle around to pass through the signal port of the miniaturized electromagnetic wave selection enclosure 10 after diffraction (diffraction), and therefore, the user's mobile phone can still have access to strong WiFi signals of the user's router 4. In this way, not only some co-frequency interference signals are filtered out, but also no normal signal communication is affected. In addition, to achieve a better effect, the mobile phone should also be equipped with the miniaturized electromagnetic wave selection enclosure 10 (not shown in the figure for simplicity of drawings), so that the user's mobile phone 7 can better communicate with the user's router 4 on condition that a strong signal or an appropriate direction of the electromagnetic wave selection enclosure is used.

The example of the present disclosure is as follows:

FIG. 2 shows signal scenario application of FIG. 1. The user's router 4 is installed into the cylindrical aluminum mesh enclosure 9. Assuming that signal ports of the cylindrical aluminum mesh enclosure 9 face the south and the north and the neighbor's router 6 is in the east of the cylindrical aluminum mesh enclosure 9, WiFi signals transmitted from the neighbor's router 6 cannot enter the cylindrical aluminum mesh enclosure 9 in a linear route, but can only enter from the signal port facing the south or the north. Because a distance from the neighbor's router 6 is long (denoted as a symbol of a remote distance 8) and there may also be many barriers such as walls, signals are very weak when reaching the cylindrical aluminum mesh enclosure 9, and because of the wrong direction, the signals cannot enter the signal port in the linear route, and the signals are excessively attenuated after diffraction (diffraction), and cannot interfere with the user's router 4. However, because the user's mobile phone 7 is close in distance, the signals are very strong, although the signal direction of the user's mobile phone may not be in line with the signal port, but there are still enough remaining strong signals after diffraction (diffraction), and therefore, the user's mobile phone can still surf the Internet through the user's router 4. In this way, not only co-frequency interference signals are filtered out, but also no normal signal communication is affected.

FIG. 5 is an enlarged view of the miniaturized apparatus with the electromagnetic wave selection enclosure 10 in FIG. 4.

FIG. 6 is a cross-sectional view of a miniaturized apparatus with the electromagnetic wave selection enclosure 10 in FIG. 4 whose internal opening is round-shaped and extends from one end to form a long and narrow structure. This is conducive to miniaturization.

### INDUSTRIAL APPLICABILITY

The present disclosure is easy to implement in industry, and the costs are also very low.

### Sequence Listing Free Text

The foregoing description only provides preferred specific implementations of the present disclosure, and the protection scope of the present disclosure is not limited thereto. Any equivalent replacement or modification made according to the technical solution and inventive concept by a person skilled in the art within a technical scope of the present disclosure shall fall within the protection scope of the present disclosure.

1-10. (canceled)

11. An apparatus for reducing interference in an antenna from a radio wave, wherein based on a wavelength of an electromagnetic wave, an antenna is enclosed by using a corresponding electromagnetic wave blocking material, and an electromagnetic wave signal port is provided so as to form an electromagnetic wave selection enclosure (wave selection enclosure), and when the wavelength satisfies a requirement for entering the signal port, an electromagnetic wave having a signal with sufficient strength, or a signal in an appropriate direction with insufficient strength, or a signal in an inappropriate direction with sufficient strength (that is, the strength and the direction jointly satisfy requirements) is allowed to enter the enclosure and communicate with the antenna, reducing or eliminating interference in the antenna in the enclosure from another electromagnetic wave outside the enclosure; and the apparatus is mainly intended to reduce or eliminate interference caused due to the co-frequency or frequency adjacency (such as interference caused for a Wireless Fidelity (WiFi) router due to the co-frequency or frequency adjacency), or interference caused by another electromagnetic wave incapable of entering the enclosure.

12. The apparatus for reducing interference in an antenna from a radio wave according to claim 11, wherein the electromagnetic wave blocking material used is an electric conductor and/or a magnetic conductor, such as a metal layer or a metal mesh, such as an aluminum mesh, a copper mesh, a silver mesh, a gold-plated mesh, a magnet mesh, or an iron mesh.

13. The apparatus for reducing interference in an antenna from a radio wave according to claim 12, wherein there is only a signal receiving antenna in the wave selection enclosure, or a number of signal receiving antennas in the wave selection enclosure is greater than a number of signal emitting antennas.

14. The apparatus for reducing interference in an antenna from a radio wave according to claim 12, wherein the antenna in the enclosure is a WiFi signal antenna (such as a WiFi antenna of a router), a 4G or 5G signal antenna of a mobile phone (or an antenna of a later generation, such as 6G or 7G), a WiFi antenna of a mobile phone, another antenna of a device with a WiFi function, or an antenna of a communications device with Bluetooth.

15. The apparatus for reducing interference in an antenna from a radio wave according to claim 12, wherein a wave absorption technology (comprising a wave absorption structure and/or a wave absorption material or a grounding technology, for example, a ferrite wave-absorbing material is used, or being grounded may refer to a connection to the ground or a simulated ground, such as a metal block) is used for a part or all of the electromagnetic wave selection enclosure (wave selection enclosure), or is used inside and/or outside the enclosure.

16. The apparatus for reducing interference in an antenna from a radio wave according to claim 13, wherein a wave absorption technology (comprising a wave absorption structure and/or a wave absorption material or a grounding technology, for example, a ferrite wave-absorbing material is used, or being grounded may refer to a connection to the ground or a simulated ground, such as a metal block) is used for a part or all of the electromagnetic wave selection enclosure (wave selection enclosure), or is used inside and/or outside the enclosure.

17. The apparatus for reducing interference in an antenna from a radio wave according to claim 12, wherein a structure of the signal port of the electromagnetic wave selection enclosure is a flaring structure expending from the inside to the outside of the enclosure, or a necking structure with diameters shrinking from the inside to the outside.

18. The apparatus for reducing interference in an antenna from a radio wave according to claim 13, wherein a structure of the signal port of the electromagnetic wave selection enclosure is a flaring structure expending from the inside to the outside of the enclosure, or a necking structure with diameters shrinking from the inside to the outside.

19. The apparatus for reducing interference in an antenna from a radio wave according to claim 12, wherein on a plane perpendicular to the signal port, only one dimension of the signal port is greater than a quarter of the wavelength of the electromagnetic wave (the electromagnetic wave of the communications antenna in the enclosure), and the other dimensions are less than a quarter of the wavelength of the electromagnetic wave.

20. The apparatus for reducing interference in an antenna from a radio wave according to claim 13, wherein on a plane perpendicular to the signal port, only one dimension of the signal port is greater than a quarter of the wavelength of the electromagnetic wave (the electromagnetic wave of the communications antenna in the enclosure), and the other dimensions are less than a quarter of the wavelength of the electromagnetic wave.

21. The apparatus for reducing interference in an antenna from a radio wave according to claim 12, wherein the electromagnetic wave selection enclosure (wave selection enclosure) is directly or indirectly installed on a rotating shaft, the rotating shaft can be driven by a motor to rotate, and a control circuit controls the motor based on a set program to further control a rotating direction of the wave selection enclosure, thereby controlling a direction of the electromagnetic wave signal port of the wave selection enclosure.

22. The apparatus for reducing interference in an antenna from a radio wave according to claim 13, wherein the electromagnetic wave selection enclosure (wave selection enclosure) is directly or indirectly installed on a rotating shaft, the rotating shaft can be driven by a motor to rotate, and a control circuit controls the motor based on a set program to further control a rotating direction of the wave selection enclosure, thereby controlling a direction of the electromagnetic wave signal port of the wave selection enclosure.

23. The apparatus for reducing interference in an antenna from a radio wave according to claim 11, wherein a signal at the signal port of the wave selection enclosure has strong strength, which can be used to enhance signal penetration in a direction of the signal port or increase a transmission distance in the direction of the signal port, for example, can be used for 5G (or 4G, or a later generation such as 6G or 7G) signal directional transmission of a mobile phone.

24. The apparatus for reducing interference in an antenna from a radio wave according to claim 12, wherein a signal at the signal port of the wave selection enclosure has strong strength, which can be used to enhance signal penetration in a direction of the signal port or increase a transmission distance in the direction of the signal port, for example, can be used for 5G (or 4G, or a later generation such as 6G or 7G) signal directional transmission of a mobile phone.

25. The apparatus for reducing interference in an antenna from a radio wave according to claim 12, wherein a turning structure is used for the wave selection enclosure, so that an electromagnetic wave signal needs to pass through one or more turning structures to reach the antenna in the enclosure after passing through the electromagnetic wave signal port of the wave selection enclosure.

26. The apparatus for reducing interference in an antenna from a radio wave according to claim 13, wherein a turning structure is used for the wave selection enclosure, so that an electromagnetic wave signal needs to pass through one or more turning structures to reach the antenna in the enclosure after passing through the electromagnetic wave signal port of the wave selection enclosure.
